(19) United States
(12) Patent Application Publication
(10) Pub. No.: US 2003/0015662 A1
(43) Pub. Date: Jan. 23, 2003

(54) Night vision device

(76) Inventors: Tzung Yung Yang, Taipei (TW); Chuang Yen Wu, Taipei Hsien (TW); Qing Zhen Li, Taipei Hsien (TW); Wen-Hao Chou, Hsi Chin city (TW)

Correspondence Address: Rabin & Champagne, P.C., Suite 500, 1101 14th Street, N.W., Washington, DC, 20005, US

(21) Appl. No.: 09/907,568

(22) Filed: Jul. 19, 2001

(51) Int. Cl. G01J 5/00

(52) U.S. Cl. 250/330

(57) ABSTRACT

A night vision device comprises a head-mounting unit, an image-acquiring unit, a light source, an image-acquiring unit, a display unit and a DC power source. The light source, the image-acquiring unit, and the display unit are arranged on the head-mounting unit and are powered by the DC power source through a connector of the head-mounting unit. The night vision device provides hand free convenience for user.

### FIELD OF THE INVENTION

The present invention relates to a night vision device, especially to a hand-free and invisible-light night vision device.

### BACKGROUND OF THE INVENTION

The searchers for disaster such as draegermen and firemen generally require searching light to facilitate their eyesight in foggy circumstances.

The conventional night vision device includes a thermal imaging device or a night vision instrument. The thermal imaging device exploits the temperature difference between living body and environment for imaging. The thermal imaging device has cumbersome size as laser printer and is expensive. The night vision instrument uses photo-multiplying tube (TMP) to amplify received light. However, the night vision instrument is not useful in foggy circumstances.

### SUMMARY OF THE INVENTION

It is the object of the present invention to provide a hand-free and invisible-light night vision device.

In one aspect of the invention, a light source, an image-acquiring unit, and a display unit are arranged on a head-mounting unit to reduce volume of the night vision device.

To achieve above object, the present invention provides a night vision device having a head-mounting unit, an image-acquiring unit, a light source, an image-acquiring unit, a display unit and a DC power source. The light source, the image-acquiring unit, and the display unit are arranged on the head-mounting unit and are powered by the DC power source through a connector of the head-mounting unit. The night vision device provides hand free convenience for user.

The various objects and advantages of the present invention will be more readily understood from the following detailed description when read in conjunction with the appended drawing, in which:

### BRIEF DESCRIPTION OF DRAWING

FIG. 1 shows a perspective view of the night vision device of the present invention;

FIG. 2 shows a schematic diagram of the present invention;

FIG. 3 shows a perspective view of the first preferred embodiment of the present invention;

FIG. 4 shows a perspective view of the second preferred embodiment of the present invention;

FIG. 5 shows a perspective view of the third preferred embodiment of the present invention; and

FIG. 6 shows a perspective view of the fourth preferred embodiment of the present invention.

### DETAILED DESCRIPTION OF THE INVENTION

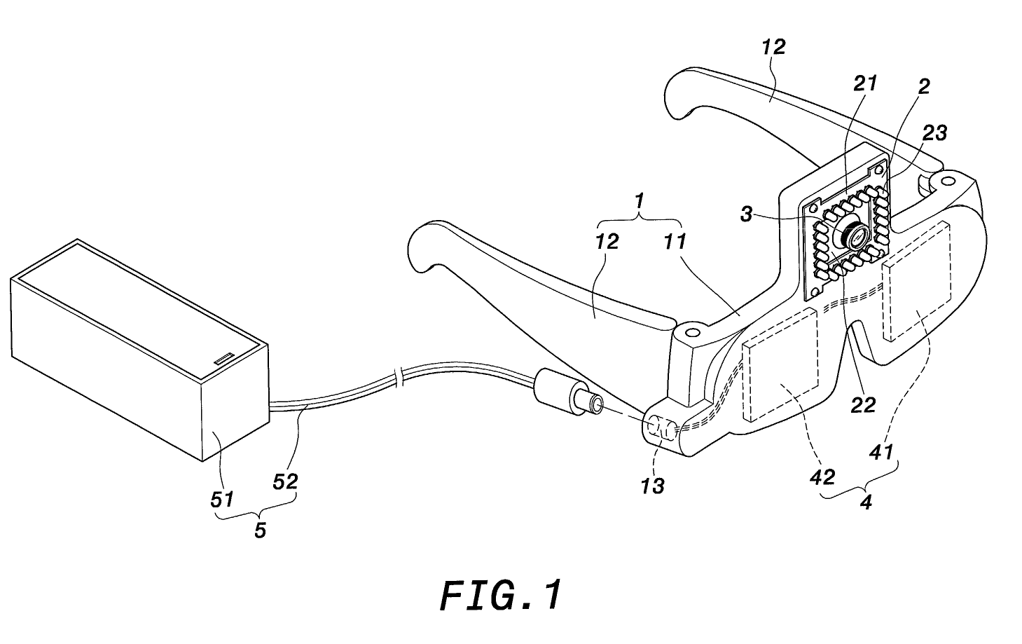

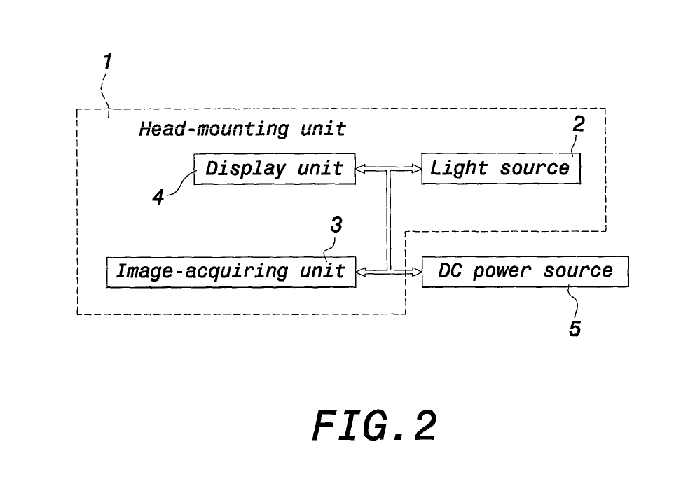

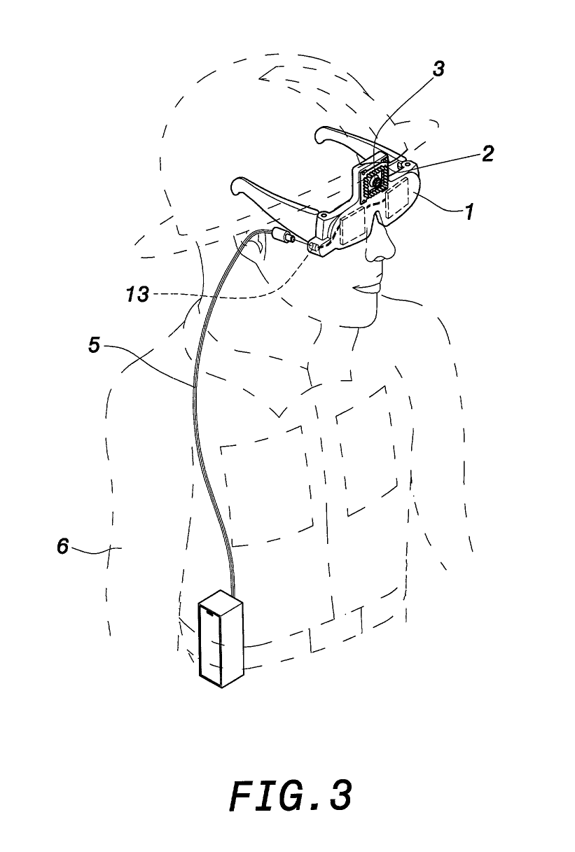

With reference now to FIGS. 1 to 3, the present invention is intended to provide a night vision device, which comprises a head-mounting unit 1, a light source 2, an image-acquiring unit 3, a display unit 4 and a DC power source 5.

The head-mounting unit 1 is an eyeglass frame in this preferred embodiment of the present invention and comprises a frame 11 and two arms 12 pivotally assembled to the frame 11. The frame 11 comprises two eyelets and has a connector 13 on one side thereof and electrically connected to the DC power source 5. The head-mounting unit 1 can be easily worn on the head of the searchers 6 for providing night vision.

The light source 2 is arranged at a center portion of the frame 11 and connected to the DC power source 5. The light source 2 comprises a circuit board 21 with a through hole 22. The light source 2 further has a plurality of infrared light emitting diodes (IR LEDs) 23 around the through hole 22. The IR LEDs 23 are powered by the DC power source 5 and generate infrared light.

The image-acquiring unit 3 is composed of video camera and lens. The image-acquiring unit 3 is arranged in the through hole 22 and assembled to the frame 11. The image-acquiring unit 3 is powered by the DC power source 5 and amplifies the detected light thereof.

The display unit 4 has two liquid crystal display panels 41 and 42 arranged on the eyelets, respectively. The liquid crystal displays 41 and 42 are powered by the DC power source 5 and used to display an image from the image-acquiring unit 3.

The DC power source 5 has a battery set 51 connected to a power cord 52, which has a free end connected to the connector 13, whereby the DC power source 5 provides electric power to the light source 2, the image-acquiring unit 3 and the display unit 4.

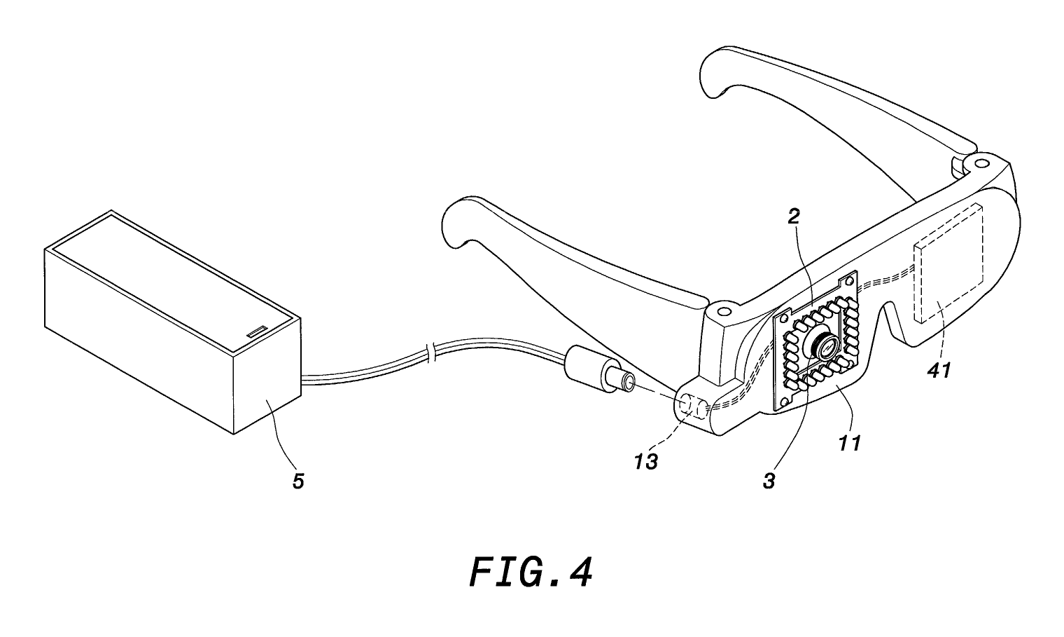

With reference to FIG. 4, the liquid crystal display panel 41 is arranged at one of the eyelets, while the light source 2 and the image-acquiring unit 3 are arranged at another one of the eyelets and connected to the DC power source 5.

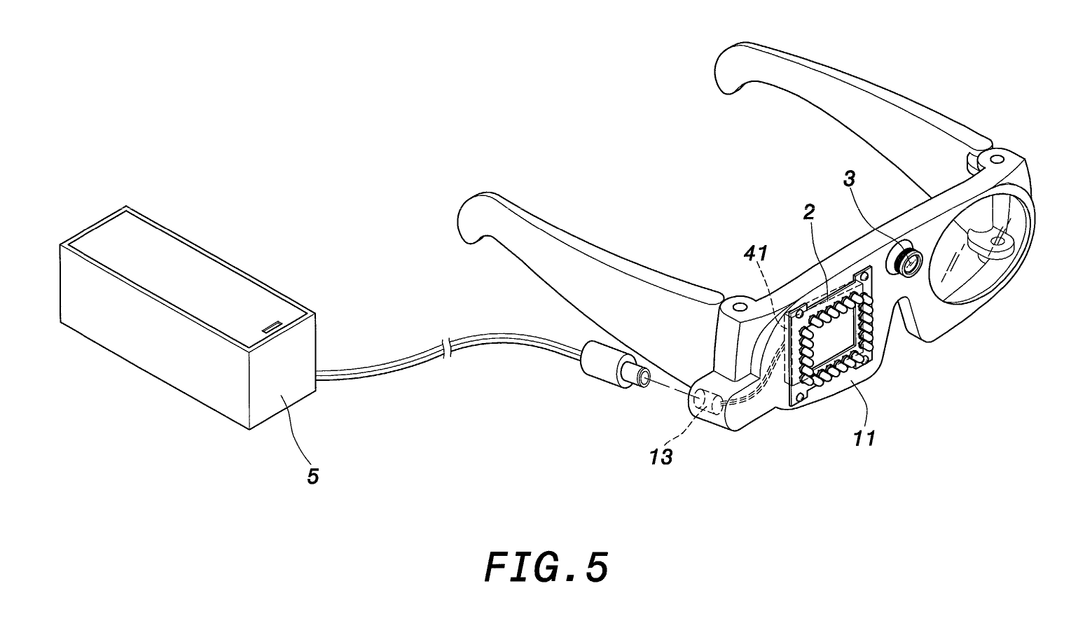

With reference to FIG. 5, the light source 2 and the display unit 4 are arranged on a frame 11 of monocle, and the image-acquiring unit 3 is arranged at center of the frame 11. The light source 2, the image-acquiring unit 3 and the display unit 4 are also powered by the DC power source 5.

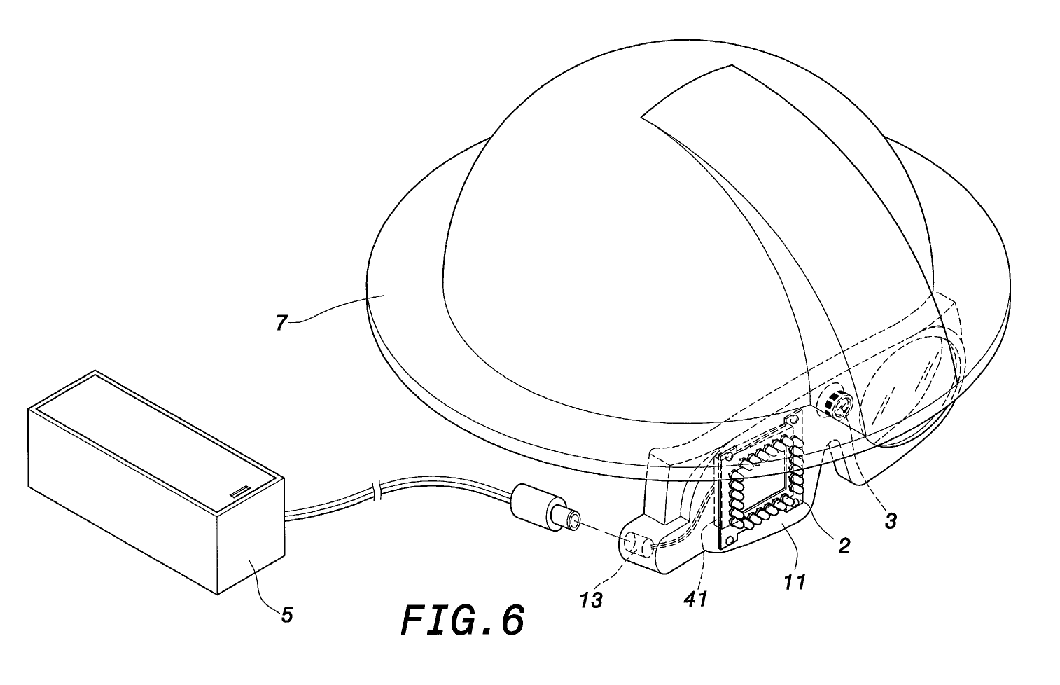

With reference to FIG. 6, the light source 2, the image-acquiring unit 3 and the display unit 4 can be arranged on a visor 7 of a hat, and are also powered by the DC power source 5.

To sum up, the night vision device of the present invention has following advantages:

1. Hand-free operation.

2. Portability.

3. Convenience.

4. Reducing cost.

5. Reducing size.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A night vision device comprising
a head-mounting unit having a connector electrically connected to a DC power source;
a light source arranged on the head-mounting unit and connected to the DC power source, the light source used to produce an invisible light;
an image-acquiring unit arranged on the head-mounting unit and connected to the DC power source, the image-acquiring unit used to amplifies a detected light thereof; and
a display unit arranged on the head-mounting unit and connected to the DC power source, the display unit used to display an image from the image-acquiring unit.

2. The night vision device as in claim 1, wherein the head-mounting unit can be glass or visor of hat.

3. The night vision device as in claim 1, wherein the light source comprises a circuit board with a through hole, and a plurality of infrared LEDs around the through hole.

4. The night vision device as in claim 1, wherein the image-acquiring unit arranged on the light source or at center of the head-mounting unit.

5. The night vision device as in claim 1, wherein the image-acquiring unit comprises a camera and a lens.

6. The night vision device as in claim 1, wherein the display unit comprises at least one LCD panel.

7. The night vision device as in claim 1, wherein the DC power source has a battery set connected to a power cord, which has a free end connected to the connector, whereby the DC power source provides electric power to other components.
